(19) United States
(12) Patent Application Publication
(10) Pub. No.: US 2026/0175324 A1
(43) Pub. Date: Jun. 25, 2026

(54) LASER PROCESSING DEVICE

(71) Applicant: MAKEX GLOBAL GROUP PTE. LTD., Singapore (SG)

(72) Inventor: Guangliang HOU, Singapore (SG)

(73) Assignee: MAKEX GLOBAL GROUP PTE. LTD., Singapore (SG)

(21) Appl. No.: 19/425,859

(22) Filed: Dec. 18, 2025

(30) Foreign Application Priority Data
Dec. 20, 2024 (CN) 202411893550.0
Dec. 20, 2024 (CN) 202423167311.5

(51) Int. Cl. B23K 26/08

(52) U.S. Cl. CPC B23K 26/0876

(57) ABSTRACT

A laser processing device includes a laser head, a control component, and a housing structure having a front chamber and a rear chamber communicating with the front chamber. The laser head is movably provided in the front chamber, the control component is provided in the rear chamber, the front chamber is communicated with an external environment such that external gas is able to enter the front chamber, and the rear chamber is communicated with the external environment such that gas in the front chamber is discharged to an outside through the rear chamber.

### CROSS-REFERENCE TO RELATED APPLICATIONS

This application claims priority to Chinese Patent Application No. 202411893550.0, filed on Dec. 20, 2024 and Chinese Patent Application No. 202423167311.5, filed on Dec. 20, 2024. All of the aforementioned applications are incorporated herein by reference in their entireties.

### TECHNICAL FIELD

The present application relates to the technical field of laser processing, and in particular to a laser processing device.

### BACKGROUND

A household laser processing device is an increasingly popular DIY tool. During laser processing, exhaust gas is generated and electronic components generate heat. Accordingly, an exhaust channel and a heat dissipation channel are usually provided. In current laser processing devices, the exhaust channel and the heat dissipation channel are usually independent of each other, so coordinated discharge of exhaust gas and heat cannot be achieved.

### SUMMARY

The present application provides a laser processing device that, in some embodiments, enables coordinated discharge of exhaust gas and heat.

To achieve the above objectives, a laser processing device according to the present application includes a laser head, a control component and a housing structure. A front chamber and a rear chamber that communicate with each other are formed inside the housing structure. The laser head is movably provided in the front chamber, and the control component is provided in the rear chamber. The front chamber is communicated with an external environment so that external gas is able to enter the front chamber, and the rear chamber is communicated with the external environment so that gas in the front chamber is able to be discharged to an outside via the rear chamber.

In an embodiment, an air inlet chamber communicating with the external environment is isolated within the rear chamber, and the air inlet chamber is communicated with the front chamber such that external gas is able to enter the front chamber through the air inlet chamber.

In an embodiment, an air inlet chamber communicating with the external environment is isolated within the rear chamber, and the air inlet chamber is communicated with the front chamber such that external gas is able to enter the front chamber through the air inlet chamber.

In an embodiment, an air guide pipe configured to communicate the air inlet chamber and the front chamber is provided between the air inlet chamber and the front chamber.

In an embodiment, a cover is provided in the rear chamber, the air inlet chamber is formed inside the cover, an air inlet communicating with the air inlet chamber is provided on the housing structure, and the external gas enters the air inlet chamber through the air inlet.

In an embodiment, the housing structure includes an outer shell body and a partition, the partition is provided within the outer shell body to divide a chamber of the outer shell body into the front chamber and the rear chamber, the partition is provided with an exhaust port to communicate the front chamber and the rear chamber, the rear chamber is provided with an air outlet communicating with the outside, and gas in the front chamber sequentially flows through the exhaust port and the air outlet to be discharged to the outside.

In an embodiment, the exhaust port and the air outlet are opposite to each other, and the laser processing device further includes a fan component that is provided in the rear chamber and located between the exhaust port and the air outlet; and the cover is provided on a side of the partition facing the rear chamber, and the cover is enclosed with the partition to form the air inlet chamber.

In an embodiment, a bottom wall of the cover is flush with a bottom wall of the outer shell body, and the air inlet is formed on the bottom wall of the outer shell body; and a support structure is provided at a bottom surface of the housing structure and is configured to raise the bottom surface of the housing structure.

In an embodiment, the cover is provided with air guide holes, the partition is provided with ventilation holes, and gas in the air inlet chamber enters the front chamber through the air guide holes and the ventilation holes.

In an embodiment, a top surface of the cover is lower than a top surface of the partition, the air guide hole is formed on a top wall of the cover, and the ventilation hole is provided at the partition and located above the air guide hole.

In an embodiment, the ventilation hole is provided at a top of the partition and extends to a top edge of the partition; and a pick-and-place opening is formed at a top of the front chamber, and the housing structure further includes a cover plate configured to cover or uncover the pick-and-place opening, and the cover plate is fitted against the top edge of the partition when covered.

In an embodiment, the rear chamber is partitioned to form an air guide chamber and an exhaust chamber arranged side by side, the cover is provided in the air guide chamber such that the air guide hole is communicated with the air guide chamber, and the ventilation hole is communicated with the air guide chamber, such that gas flow in the air inlet chamber enters the air guide chamber through the air guide hole and then enters the front chamber through the ventilation hole; and both the exhaust port and the air outlet are communicated with the exhaust chamber, and the control component is provided within the air guide chamber.

In an embodiment, two air guide chambers are provided, the two air guide chambers are respectively provided on opposite sides of the exhaust chamber, and one cover is provided in each air guide chamber; and the control component includes a first control element and a second control element electrically connected to the first control element, the first control element is provided in one of the air guide chambers, the second control element is provided in another one of the air guide chambers, and the laser head is electrically connected to the first control element or the second control element; and two baffles are provided in the rear chamber to divide the rear chamber into the air guide chambers and the exhaust chamber.

In an embodiment, a pick-and-place opening is formed at a top of the front chamber, and the housing structure further includes a cover plate configured to cover or uncover the pick-and-place opening; and the laser processing device further includes a track mechanism, the track mechanism includes two first tracks and a second track, the two first tracks are provided at opposite sides of the front chamber along a first direction, the second track is reciprocally provided on the two first tracks along a second direction, and the laser head is movably provided on the second track.

The present application further provides a laser processing device, including: a housing structure having a front chamber and a rear chamber communicating with each other and having an air outlet provided at a side wall of the rear chamber; a laser head movably provided within the front chamber; and a fan component provided in the rear chamber and located opposite to the air outlet.

In an embodiment, the housing structure includes an outer shell body and a partition, the partition is provided within the outer shell body to divide a chamber of the outer shell body into the front chamber and the rear chamber, an exhaust port is provided on the partition to communicate the front chamber and the rear chamber, the exhaust port is opposite to the air outlet, and the fan component is provided between the exhaust port and the air outlet.

In an embodiment, the laser processing device further includes a control component provided in the rear chamber and arranged side by side with the fan component; and the rear chamber is provided with two baffles to divide the rear chamber into a first chamber, a second chamber and a third chamber arranged side by side, the first chamber and the third chamber are respectively provided on opposite sides of the second chamber, the exhaust port and the air outlet are communicated with the second chamber, and the fan component is provided in the second chamber; and the control component includes a first control element and a second control element electrically connected to the first control element, the first control element is provided in the first chamber and the second control element is provided in the third chamber, and the fan component is electrically connected to the first control element or the second control element.

In an embodiment, the first control element is one of a main control board and a power module, and the second control element is another one of the main control board and the power module; and a baffle is provided with a wire-passing hole for a wire harness to pass through, the wire-passing hole is provided at a top of the baffle and extends to a top edge of the baffle.

In an embodiment, the first control element is attached to a side of the partition facing the first chamber, and the second control element is attached to a bottom wall of the third chamber; and a first mounting post protrudes from the side of the partition facing the first chamber, and the first control element is fixedly connected to the first mounting post by fasteners; and/or a second mounting post is provided on the bottom wall of the third chamber, and the second control element is fixedly connected to the second mounting post by fasteners.

In an embodiment, the housing structure further includes a top plate detachably provided at a top of the rear chamber; and a pick-and-place opening is formed at a top of the front chamber, and the housing structure further includes a cover plate configured to cover or uncover the pick-and-place opening; the laser processing device further includes a lighting lamp provided within the front chamber; and one of the cover plate and the outer shell body is provided with a magnetic element, and another one of the cover plate and the outer shell body is provided with a Hall sensor configured to cooperate with the magnetic element, the Hall sensor is configured to detect opening and closing of the cover plate, the Hall sensor and the lighting lamp are electrically connected to the control component of the laser processing device, and the control component is configured to control brightness of the lighting lamp according to a sensing signal of the Hall sensor.

In an embodiment, the laser processing device further includes a track mechanism, the track mechanism includes two first tracks and a second track, the two first tracks are provided at opposite sides of the front chamber along a first direction, the second track is reciprocally provided on the two first tracks along a second direction, and the laser head is movably provided on the second track.

In the laser processing device, a front chamber and a rear chamber communicate with each other and form a shared airflow path for exhausting gas from the front chamber and dissipating heat from a control component in the rear chamber, thereby simplifying the airflow structure and improving exhaust and heat dissipation performance.

### BRIEF DESCRIPTION OF THE DRAWINGS

To more clearly illustrate the technical solutions in the embodiments of this application or the prior art, the drawings used in the description of the embodiments or the prior art will be briefly introduced below. Obviously, the drawings described below are only some embodiments of this application. For those skilled in the art, other drawings can be obtained based on the structures shown in these drawings without creative effort.

FIG. 1 is a structural schematic view of a laser processing device according to an embodiment of the present application.

FIG. 2 is a partial structural schematic view of the laser processing device according to an embodiment of the present application.

FIG. 3 is a structural schematic view of the laser processing device according to an embodiment of the present application from another perspective.

FIG. 4 is a structural schematic view of the laser processing device according to another embodiment of the present application.

FIG. 5 is a bottom view of the laser processing device according to an embodiment of the present application.

FIG. 6 is a schematic view of an assembly of a laser head and a track mechanism of laser processing device according to an embodiment of the present application.

FIG. 7 is a structural schematic view of the laser processing device according to an embodiment of the present application.

FIG. 8 is a partial structural schematic view of the laser processing device according to an embodiment of the present application.

FIG. 9 is a structural schematic view of FIG. 8 from another perspective.

FIG. 10 is a schematic view of another partial structure of the laser processing device according to an embodiment of the present application.

Realization of the objectives, functional features and advantages of the present application will be further described in conjunction with the embodiments and with reference to the drawings.

### DETAILED DESCRIPTION OF THE EMBODIMENTS

The technical solutions of the embodiments of the present application will be clearly and completely described below with reference to the drawings of the embodiments of the present application. It is apparent that the described embodiments are only part of the embodiments of the present application, rather than all of the embodiments. Based on the embodiments in the present application, all other embodiments obtained by those of ordinary skill in the art without creative efforts fall within the protection scope of the present application.

It should be noted that, if directional indications (such as up, down, left, right, front, rear, etc.) are involved in the embodiments of the present application, the directional indications are merely used for explaining relative positional relationships, movement conditions and the like between components under a certain specific posture. When the specific posture is changed, the directional indications are correspondingly changed.

In addition, if descriptions such as “first” and “second” are involved in the embodiments of the present application, the descriptions of “first” and “second” are merely used for descriptive purposes, and should not be construed as indicating or implying their relative importance or implicitly specifying the number of indicated technical features. Therefore, features defined as “first” or “second” may explicitly or implicitly include at least one of such features. In addition, if “and/or” or “and/or” appears throughout the specification, it refers to three parallel options. For example, “A and/or B” includes a case of A alone, or B alone, or both A and B simultaneously. Furthermore, the technical solutions among the embodiments can be combined with each other, but such combinations must be based on the capability of those skilled in the art to implement them. When the combination of the technical solutions results in mutual contradictions or is technically unfeasible, it should be considered that such combinations do not exist and are not within the protection scope of the present application.

The present application provides a laser processing device 100.

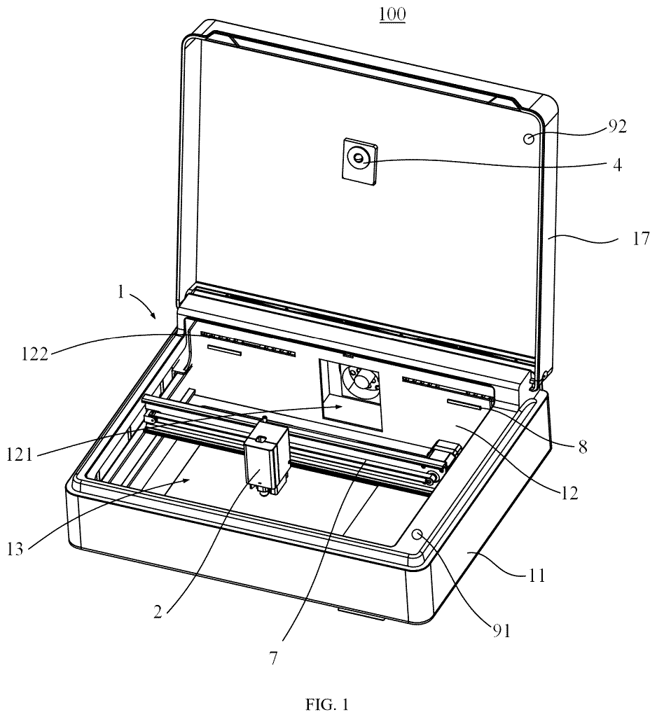

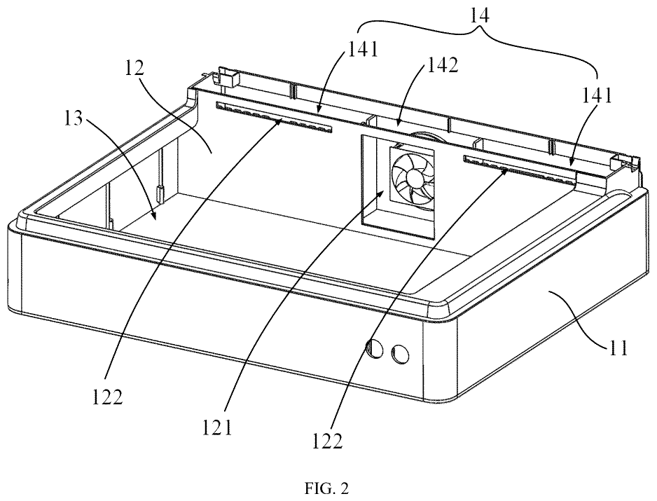

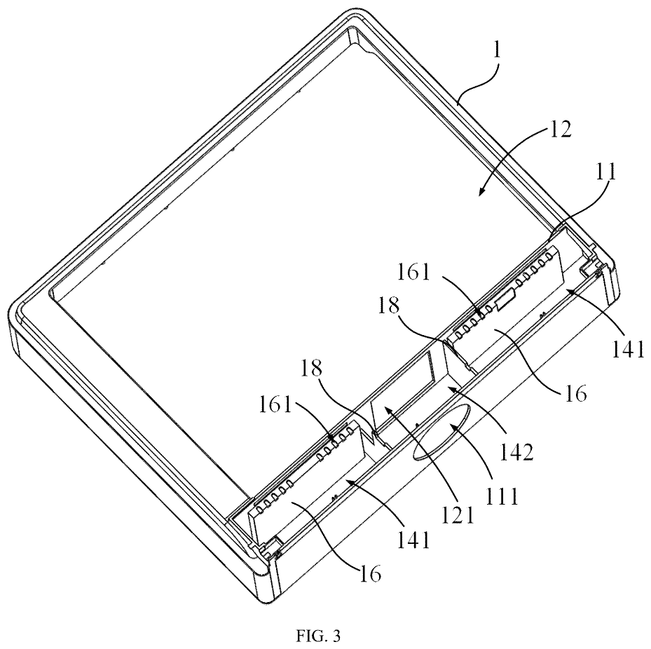

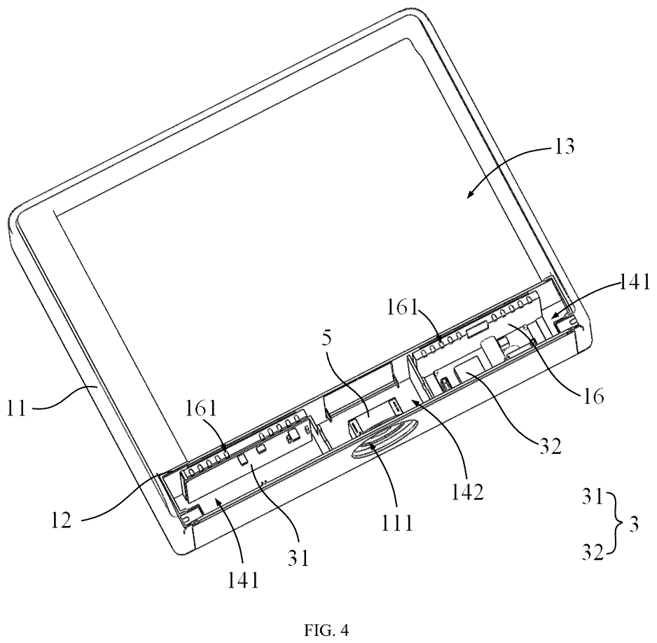

As shown in FIG. 1 to FIG. 5, a laser processing device 100 includes a laser head 2, a control component 3 and a housing structure 1. A front chamber 13 and a rear chamber 14 communicating with each other are formed inside the housing structure 1. The laser head 2 is movably provided in the front chamber 13, and the control component 3 is provided in the rear chamber 14. The front chamber 13 is communicated with an external environment such that external gas is able to enter the front chamber 13, and the rear chamber 14 is communicated with the external environment such that gas in the front chamber 13 is discharged to an outside through the rear chamber 14.

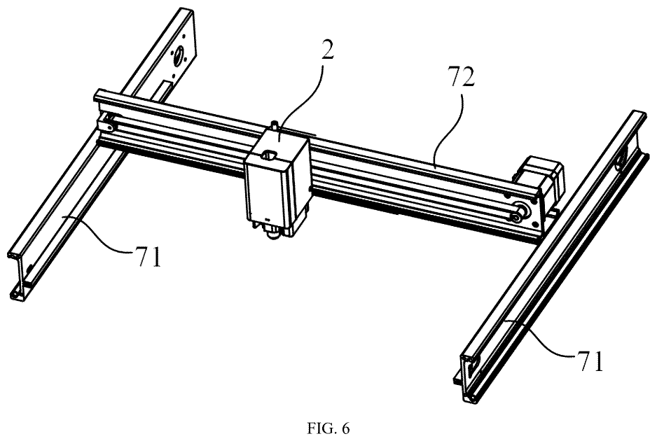

The laser processing device 100 may include, but is not limited to, devices that perform processing using a laser, such as a laser engraving machine, a laser cutting machine and a laser marking machine. The housing structure 1 serves as a supporting base of the device and defines a front chamber 13 configured to accommodate the laser head 2 and a rear chamber 14 configured to accommodate the control component 3. A volume of the front chamber 13 is greater than a volume of the rear chamber 14. The laser head 2 is movably provided in the front chamber 13 such that the laser head 2 is able to translate within the front chamber 13 and thereby move to different positions for processing. The laser head 2 is slidably connected to a top wall of the front chamber 13. In an embodiment, a track mechanism 7 is provided in the front chamber 13. For example, the track mechanism 7 includes two first tracks 71 and a second track 72. As shown in FIG. 1 and FIG. 6, the two first tracks 71 are provided at opposite sides of the front chamber 13 along a first direction, and the second track 72 is reciprocally provided on the two first tracks 71 along a second direction. The laser head 2 is movably provided on the second track 72. In this manner, the laser head 2 is able to slide along an extension direction of the second track 72 and is also able to slide along an extension direction of the first tracks 71 together with the second track 72, such that the laser head 2 is able to move to different positions for processing.

The track mechanism 7 may employ a pulley-based transmission manner (that is, a combination of pulleys and a belt). In an embodiment, the track mechanism 7 employs a sprocket-based transmission manner (that is, a combination of sprockets and a chain). The present application does not limit a transmission manner of the track mechanism 7 as long as the track mechanism 7 is able to drive the laser head 2 to move. In addition, the track mechanism 7 is able to drive the laser head 2 to slide in a horizontal direction. In an embodiment, the track mechanism 7 is further able to drive the laser head 2 to slide in a vertical direction. The present application does not limit these aspects.

The control component 3 includes, but is not limited to, a control circuit board, a power module and a cooling fan. The control circuit board is electrically connected to the laser head 2 and is configured to control movement of the laser head 2 within the front chamber 13.

A camera 4 is further provided in the front chamber 13. As shown in FIG. 1, the camera 4 is located at the top of the front chamber 13 and is used to capture photographs of the processing area to obtain an image of a workpiece to be processed, so that the processing device can obtain a position of the workpiece to be processed and determine material information of the workpiece to be processed (such as thickness and hardness) based on the image to achieve precise processing. The camera 4 is further used to obtain a processing pattern so that the processing device can perform processing according to the processing pattern.

When the laser head 2 performs laser processing in the front chamber 13, exhaust gas is generated, and when the control component 3 operates in the rear chamber 14, heat is generated. In a traditional laser processing device 100, an exhaust channel and a heat-dissipation channel are typically independent of each other, and coordinated management of exhaust gas and heat cannot be achieved. In the present laser processing device 100, the front chamber 13 and the rear chamber 14 are communicated with each other, and the front chamber 13 and the rear chamber 14 are respectively communicated with an external environment. For example, an air inlet is formed in a bottom wall and/or a side wall of the front chamber 13 to communicate the external environment with the front chamber 13, and an air outlet is formed in a bottom wall and/or a side wall of the rear chamber 14 to communicate the external environment with the rear chamber 14. The present laser processing device 100 is able to form an airflow path as follows: external air enters the front chamber 13, flows from the front chamber 13 into the rear chamber 14, and is finally discharged from the rear chamber 14 to the outside. As air flows from the front chamber 13 to the rear chamber 14, fresh air is able to be timely supplemented to the front chamber 13, carrying away exhaust gas generated during a laser processing process and reducing working heat and an exhaust-gas concentration in the front chamber 13. As the air subsequently flows into the rear chamber 14, the air is able to continue to carry away heat generated by the control component 3, and finally the air is discharged from the rear chamber 14 to the external environment to complete exhaust-gas discharge and heat dissipation. In summary, the present technical solution is able to effectively discharge exhaust gas generated during laser processing and heat generated by the control component 3 with a single airflow path. Compared with independent exhaust channels and heat-dissipation channels, an airflow structure is simplified, and an overall exhaust-gas discharge efficiency and heat-dissipation efficiency of the device are improved.

In the rear chamber 14, a fan component 5 is further provided. The fan component 5 is used to actively draw air from the front chamber 13 into the rear chamber 14, thereby enhancing an airflow from the front chamber 13 toward the rear chamber 14 and ensuring that air in the front chamber 13 is able to be quickly and uniformly drawn into the rear chamber 14.

In some embodiments of the present application, an air inlet chamber 15 that is communicated with an external environment is partitioned within the rear chamber 14. The air inlet chamber 15 is communicated with the front chamber 13 so that external air is able to enter the front chamber 13 via the air inlet chamber 15. The provision of the air inlet chamber 15 enables external air to pass through a narrow region before flowing into the front chamber 13, thereby increasing the flow velocity and more effectively delivering fresh air to the front chamber 13, which improves the efficiency of air exchange.

In an embodiment, an air guide pipe configured to communicate the air inlet chamber 15 and the front chamber 13 is provided between the air inlet chamber 15 and the front chamber 13, that is, the air inlet chamber 15 and the front chamber 13 are communicated through the air guide pipe such that gas in the air inlet chamber 15 enters the front chamber 13 via the air guide pipe. Provision of the air guide pipe provides a closed airflow path, ensures that gas in the air inlet chamber 15 flows into the front chamber 13 along a determined path, improves directionality of airflow, reduces disturbances and vortices during gas flow, and reduces disorder of airflow.

In an embodiment, a cover 16 is provided in the rear chamber 14. The cover 16 may be provided to cover a side wall of the rear chamber 14, or may be provided spaced apart from the side wall of the rear chamber 14. When the cover 16 is provided to cover the side wall of the rear chamber 14, the cover 16 is enclosed with the side wall of the rear chamber 14 to form the air inlet chamber 15. When the cover 16 is provided spaced apart from the side wall of the rear chamber 14, the cover 16 itself encloses the air inlet chamber 15. An air inlet 112 communicated with the air inlet chamber 15 is formed on the housing structure 1. The air inlet 112 may be formed in the side wall of the rear chamber 14 or in a bottom wall of the rear chamber 14 so that external air is able to enter the air inlet chamber 15 via the air inlet 112.

In an embodiment, the housing structure 1 includes an outer shell body 11 and a partition 12. The partition 12 is provided within the outer shell body 11 to divide a chamber of the outer shell body 11 into the front chamber 13 and the rear chamber 14. An exhaust port 121 is formed in the partition 12 to communicate the front chamber 13 and the rear chamber 14. The rear chamber 14 is formed with an air outlet 111 communicating with an external environment. Gas in the front chamber 13 sequentially flows through the exhaust port 121 and the air outlet 111 to be discharged to the outside.

In this embodiment, the partition 12 is provided inside the outer shell body 11 to divide the chamber of the outer shell body 11 so as to obtain the front chamber 13 and the rear chamber 14, and then the exhaust port 121 is formed in the partition 12 to communicate the front chamber 13 and the rear chamber 14. In this way, gas in the front chamber 13 enters the rear chamber 14 via the exhaust port 121 and is then discharged to the outside from the air outlet 111. The air outlet 111 is opposite to the exhaust port 121, and the fan component 5 is provided between the air outlet 111 and the exhaust port 121, which is able to reduce a distance between the air outlet 111 and the exhaust port 121 such that gas flowing out from the exhaust port 121 is able to be quickly discharged from the air outlet 111, thereby improving exhaust efficiency.

A pick-and-place opening is formed at a top of the front chamber 13. As shown in FIG. 1, the housing structure 1 further includes a cover plate 17, and the cover plate 17 is used to open or cover the pick-and-place opening. The cover plate 17 may be connected to the outer shell body 11. For example, the cover plate 17 may be rotatably connected to the outer shell body 11 such that the pick-and-place opening is opened or covered by rotating the cover plate 17. In an embodiment, the cover plate 17 is slidably connected to the outer shell body 11 such that the pick-and-place opening is opened or covered by sliding the cover plate 17. In another embodiment, the cover plate 17 is not connected to the outer shell body 11, that is, the cover plate 17 and the outer shell body 11 are provided separately. When the pick-and-place opening needs to be covered, the cover plate 17 is directly placed on the outer shell body 11. When the pick-and-place opening needs to be opened, the cover plate 17 is directly removed. The present application does not limit a connection manner between the cover plate 17 and the outer shell body 11 as long as the pick-and-place opening is able to be opened and covered, so that an operator is able to conveniently place a workpiece into the front chamber 13 or take out a processed workpiece from the front chamber 13. During a laser processing process, when the cover plate 17 is in a covered state, laser overflow is avoided, smoke and dust generated during the laser processing process are prevented from diffusing outward, and foreign matter from outside is prevented from entering the front chamber 13 and affecting processing.

In an embodiment, the cover 16 is provided on a side of the partition 12 facing the rear chamber 14, and the cover 16 is enclosed with the partition 12 to form the air inlet chamber 15. The cover 16 includes a top plate and a side plate bent from the top plate, and an end surface of the side plate is connected to the partition 12 so that the cover 16 is enclosed with the partition 12 to form the air inlet chamber 15. The cover 16 is provided in abutment with the partition 12 instead of being spaced apart therefrom. On the one hand, a distance between the air inlet chamber 15 and the front chamber 13 is able to be reduced so that gas in the air inlet chamber 15 is able to quickly flow into the front chamber 13. On the other hand, no additional space needs to be reserved for a gap between the cover 16 and the partition 12, which facilitates flexible arrangement of the control component 3 in the rear chamber 14.

In an embodiment, a bottom wall of the cover 16 is flush with a bottom wall of the outer shell body 11, and the air inlet 112 is formed in the bottom wall of the outer shell body 11. The air inlet 112 provided at a bottom portion of the outer shell body 11 is able to be hidden. When the housing structure 1 is placed on a desktop, the air inlet 112 is not visible to the naked eye, which not only improves an overall appearance texture of the device, but also reduces a possibility that dust or debris in daily life enters the air inlet chamber 15.

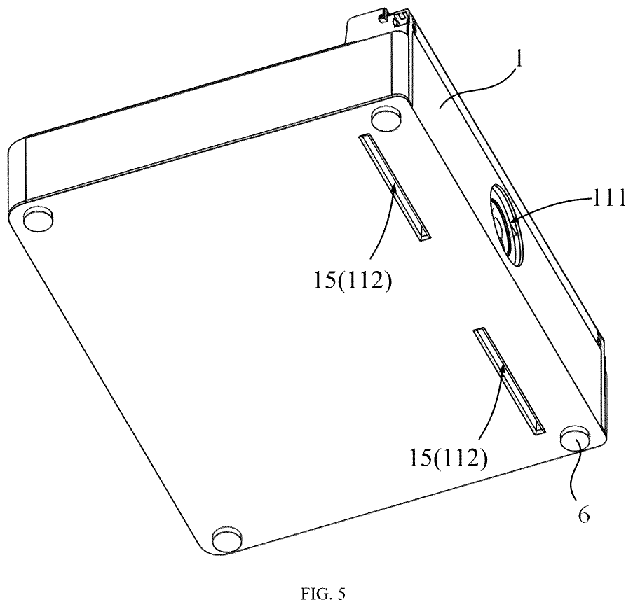

Furthermore, as shown in FIG. 5, a support structure 6 protrudes from a bottom surface of the housing structure 1, and the support structure 6 is used to raise the bottom surface of the housing structure 1. The support structure 6 may include, but is not limited to, protrusions and rubber pads. The support structure 6 is uniformly arranged on the bottom surface of the housing structure 1 to raise the bottom surface of the housing structure 1, so that when the housing structure 1 is placed on a desktop, a clearance region is formed between the bottom surface of the housing structure 1 and the desktop, thereby preventing the air inlet 112 from being blocked by the desktop and facilitating external air to pass through the air inlet 112 and enter the air inlet chamber 15.

An air guide hole 161 is formed in the cover 16, and a ventilation hole 122 is formed in the partition 12. Gas in the air inlet chamber 15 enters the rear chamber 14 through the air guide hole 161 and then enters the front chamber 13 through the ventilation hole 122. The air guide hole 161 and the ventilation hole 122 are in communication. The air guide hole 161 and the ventilation hole 122 may be in closed communication or in open communication. In closed communication, for example, an air guide pipe is provided between the air guide hole 161 and the ventilation hole 122. In this case, gas in the air inlet chamber 15 enters the air guide pipe through the air guide hole 161 and then enters the front chamber 13 through the ventilation hole 122. In open communication, for example, both the air guide hole 161 and the ventilation hole 122 are communicated with the rear chamber 14. In this case, gas in the air inlet chamber 15 enters the rear chamber 14 through the air guide hole 161 and then enters the front chamber 13 through the ventilation hole 122. In the following embodiments, both the air guide hole 161 and the ventilation hole 122 are communicated with the rear chamber 14.

In some embodiments, a top surface of the cover 16 is lower than a top surface of the partition 12, the air guide hole 161 is formed on a top wall of the cover 16, and the ventilation hole 122 is provided at the partition 12 and located above the air guide hole 161. With this arrangement, a distance between the air guide hole 161 and the ventilation hole 122 is able to be reduced, so that gas discharged from the air guide hole 161 is able to quickly pass through the ventilation hole 122 and enter the front chamber 13, thereby reducing a loss of air volume and improving an exhaust efficiency of the front chamber 13.

In an embodiment, the ventilation hole 122 is provided at a top portion of the partition 12 and extends to a top edge of the partition 12. In this case, when the cover plate 17 is in a covered state, the cover plate 17 is fitted against the top edge of the partition 12. It is readily understood that gas flowing from the air guide hole 161 into the rear chamber 14 tends to rise. In this embodiment, the ventilation hole 122 is provided at the top portion of the partition 12 and extends to the top edge of the partition 12, so that when the rising airflow is blocked by the cover plate 17, the airflow is guided to turn toward the ventilation hole 122. In this way, natural convection of gas is used to promote gas flow, which is able to reduce vortices and disturbances of gas in the rear chamber 14 and help maintain stability and continuity of airflow.

Furthermore, in an embodiment of the present application, at least two air guide holes 161 are provided, and two or more air guide holes 161 are arranged at intervals on a top wall of the cover 16. A design with a plurality of air guide holes 161 is able to increase airflow passages between the air inlet chamber 15 and an air guide chamber 141, help form a uniform airflow distribution in the air guide chamber 141, and make pressure compensation in the front chamber 13 more uniform.

In an embodiment of the present application, an air guide chamber 141 and an exhaust chamber 142 arranged side by side are partitioned in the rear chamber 14. The cover 16 is provided in the air guide chamber 141 so that the air guide hole 161 is communicated with the air guide chamber 141, and the ventilation hole 122 is communicated with the air guide chamber 141. In this case, gas in the air inlet chamber 15 flows into the air guide chamber 141 through the air guide hole 161 and then enters the front chamber 13 through the ventilation hole 122. Meanwhile, both the exhaust port 121 and the air outlet 111 are communicated with the exhaust chamber 142. The control component 3 is provided in the air guide chamber 141, and the fan component 5 is provided in the exhaust chamber 142.

In this embodiment, a flow path of gas is as follows. External gas enters the air inlet chamber 15 through the air inlet 112, then enters the air guide chamber 141 through the air guide hole 161, then enters the front chamber 13 through the ventilation hole 122. Gas in the front chamber 13 enters the exhaust chamber 142 through the exhaust port 121, and is finally discharged to the outside from the air outlet 111. In this embodiment, the rear chamber 14 is partitioned to form the air guide chamber 141 and the exhaust chamber 142 arranged side by side, so that an intake path and an exhaust path of gas are isolated from each other, which is able to reduce interference between two opposing airflows and improve stability of gas flow. Since the control component 3 is provided in the air guide chamber 141, gas first enters the air guide chamber 141 from the air guide hole 161 and then enters the front chamber 13 through the ventilation hole 122, so that the airflow first dissipates heat from the control component 3 and then flows into the front chamber 13 to reduce a concentration of exhaust gas in the front chamber 13. With this arrangement, an influence of exhaust gas and dust in the front chamber 13 on the control component 3 is able to be reduced.

In some embodiments, the control component 3 includes a first control element 31 and a second control element 32 that are electrically connected to each other. For example, the first control element 31 is one of a main control board and a power module, and the second control element 32 is another one of the main control board and the power module. Of course, the first control element 31 and the second control element 32 may also be other required elements such as a communication module or a wireless connection module, which are not limited in the present application. To mount the first control element 31 and the second control element 32, two air guide chambers 141 are provided. The two air guide chambers 141 are respectively provided on opposite sides of the exhaust chamber 142, and one cover 16 is provided in each air guide chamber 141. The first control element 31 is provided in one air guide chamber 141, the second control element 32 is provided in another air guide chamber 141, and the laser head 2 is electrically connected to the first control element 31 or the second control element 32.

In an embodiment, two baffles 18 are provided in the rear chamber 14 to divide the rear chamber 14 into two air guide chambers 141 and one exhaust chamber 142. In an embodiment, the two baffles 18 are used to explicitly partition the rear chamber 14 into the two air guide chambers 141 and the exhaust chamber 142. Partitioning with the baffles 18 is able to prevent gas in the air guide chambers 141 from flowing into the exhaust chamber 142 and prevent gas in the exhaust chamber 142 from flowing into the air guide chambers 141.

In an embodiment, the two air guide chambers 141 are provided, and each air guide chamber 141 is used to accommodate one control element, so that heat of the control component 3 is dispersed, heat concentration is avoided, and heat dissipation efficiency is improved. In addition, two intake paths are provided, which is able to provide a larger intake area and ensure that heat in the rear chamber 14 and exhaust gas in the front chamber 13 are sufficiently discharged. Meanwhile, the two air guide chambers 141 are symmetrically provided at two sides of the exhaust chamber 142, so that an airflow pattern of intake at both sides and exhaust in the middle is formed, which helps maintain balance of airflow inside the front chamber 13.

As shown in FIG. 1, in some embodiments, the laser processing device 100 further includes a lighting lamp 8. The lighting lamp 8 is provided in the front chamber 13 and is used to illuminate a workpiece.

In an embodiment, the lighting lamp 8 may be provided on the partition 12 and located at a left side and/or a right side of the front chamber 13. With this arrangement, when the lighting lamp 8 operates, a user normally stands at a front side of the front chamber 13, and since the lighting lamp 8 is provided at the left side and/or the right side of the front chamber 13, light emitted from the lighting lamp 8 is prevented from directly irradiating towards eyes of the user, thereby improving safety in use. In addition, provision of the lighting lamp 8 is able to illuminate the front chamber 13, thereby helping the camera 4 capture a clearer image.

In some embodiments, one of the cover plate 17 and the outer shell body 11 is provided with a magnetic element 91, and another one of the cover plate 17 and the outer shell body 11 is provided with a Hall sensor 92 that cooperates with the magnetic element 91 and is configured to detect opening and closing of the cover plate 17. The Hall sensor 92 and the lighting lamp 8 are electrically connected to the control component 3, and the control component 3 is configured to control brightness of the lighting lamp 8 according to a sensing signal of the Hall sensor 92.

The Hall sensor 92 is used to detect opening and closing of the cover plate 17, and the control component 3 is configured to control brightness of the lighting lamp 8 according to a sensing signal of the Hall sensor 92. In an embodiment, the Hall sensor 92 cooperates with the magnetic element 91 to generate a sensing signal when the cover plate 17 is opened or closed. When the Hall sensor 92 senses the magnetic element 91, this indicates that the cover plate 17 covers the pick-and-place opening. At this time, the Hall sensor 92 sends a first sensing signal to the control component 3. The control component 3 receives the first sensing signal and controls brightness of the lighting lamp 8 according to the first sensing signal. Since the cover plate 17 covers the pick-and-place opening at this time, brightness of the lighting lamp 8 is able to be increased. When the Hall sensor 92 does not sense the magnetic element 91, this indicates that the cover plate 17 is in an open state. At this time, the Hall sensor 92 sends a second sensing signal to the control component 3. The control component 3 receives the second sensing signal and controls brightness of the lighting lamp 8 according to the second sensing signal. Since the cover plate 17 is in the open state at this time, brightness of the lighting lamp 8 is able to be decreased or the lighting lamp 8 is directly turned off.

In summary, in an embodiment, one of the cover plate 17 and the outer shell body 11 is provided with the magnetic element 91, such as a magnet, another one of the cover plate 17 and the outer shell body 11 is provided with the Hall sensor 92, and the Hall sensor 92 and the lighting lamp 8 are electrically connected to the control component 3, so that brightness of the lighting lamp 8 is associated with opening and closing of the cover plate 17. As a result, the lighting lamp 8 is able to rapidly adjust brightness according to opening and closing of the cover plate 17, thereby improving intelligence and flexibility of the laser processing device 100.

A household laser processing device allows a user to perform laser engraving and cutting on various materials at home, and is an increasingly popular DIY tool. A working chamber is formed inside a housing of the laser processing device. A laser head emits laser in the working chamber and moves along a preset trajectory, so as to complete a laser engraving or cutting process.

In related art, a laser engraving process generates exhaust gas. To timely discharge exhaust gas in a working chamber, a laser processing device is further provided with an exhaust system. The exhaust system mainly uses rotation of a fan to extract the exhaust gas from the working chamber. At present, most laser processing devices usually have a fan mounted on an outer side wall of a housing, which affects neatness of an appearance of the laser processing device.

The present application provides a laser processing device 100, which is intended to embed a fan component in the laser processing device, so as to improve neatness of the laser processing device. The laser processing device 100 may be, but is not limited to, a device that performs processing by using laser such as a laser engraving machine, a laser cutting machine, and a laser marking machine.

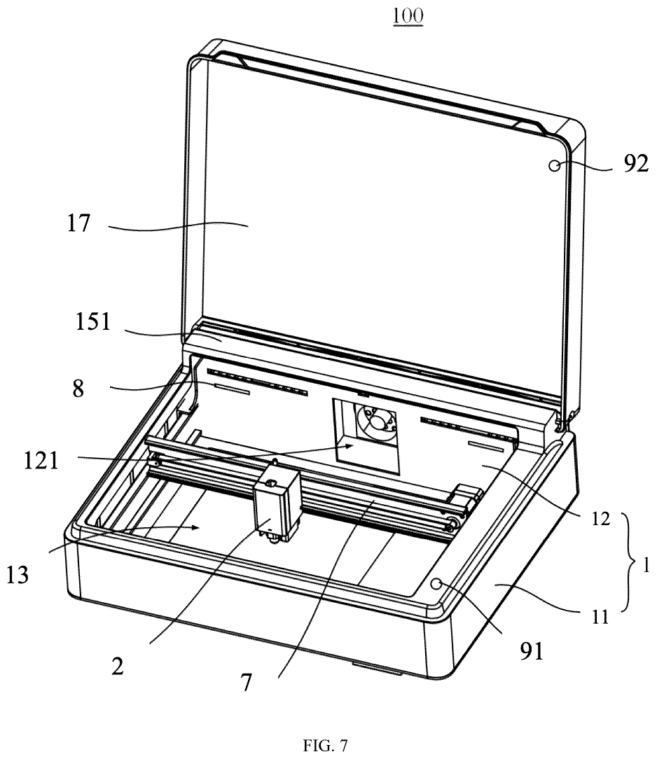

As shown in FIG. 7 to FIG. 9, the laser processing device 100 includes a housing structure 1, a laser head 2, and a fan component 5. A front chamber 13 and a rear chamber 14 that communicate with each other are provided in the housing structure 1. A side wall of the rear chamber 14 is provided with an air outlet 111. The laser head 2 is movably provided in the front chamber 13. The fan component 5 is provided in the rear chamber 14 and is opposite to the air outlet 111.

The housing structure 1 serves as a supporting base of the device, and a front chamber 13 for accommodating the laser head 2 and a rear chamber 14 for accommodating the fan component 5 are formed in the housing structure 1. The laser head 2 is configured to emit laser to perform laser processing on a workpiece. The laser head 2 is movably provided in the front chamber 13 such that the laser head 2 is able to translate in the front chamber 13 and is able to be moved to different positions for processing. The laser head 2 can be slidably connected to a top wall of the front chamber 13, or a track mechanism 7 can be provided in the front chamber 13, the laser head 2 is slidably provided on the track mechanism 7, and the track mechanism 7 can use a pulley transmission manner (that is, a combination of a pulley and a belt), or can use a sprocket transmission manner (that is, a combination of a sprocket and a chain). In the present application, a transmission manner of the track mechanism 7 is not limited, as long as the track mechanism 7 is able to drive the laser head 2 to move. In addition, the track mechanism 7 can drive the laser head 2 to slide in a horizontal direction, and can further drive the laser head 2 to slide in a vertical direction. In the present application, this is not limited.

As shown in FIG. 6, in an embodiment, the laser processing device 100 further includes a track mechanism 7. The track mechanism 7 includes two first tracks 71 and a second track 72. The two first tracks 71 are provided at opposite sides of the front chamber 13 along a first direction, the second track 72 is reciprocally provided on the two first tracks 71 along a second direction, and the laser head 2 is movably provided on the second track 72. The first direction and the second direction are two directions perpendicular to each other. In this way, the laser head 2 is able to slide on the second track 72 along an extension direction of the second track 72, and is also able to slide together with the second track 72 along an extension direction of the first tracks 71, so that the laser head 2 can be moved to different positions for processing.

In conventional laser processing devices 100, the fan component 5 is usually mounted on an outer side wall of the housing structure 1, which causes an overall appearance of the laser processing device 100 to have a protruding structure and thus affects neatness of an appearance of the laser processing device 100. Unlike the conventional laser processing device 100, in the laser processing device 100 of the present application, the housing structure 1 is internally provided with a front chamber 13 and a rear chamber 14 that are communicated with each other, and a side wall of the rear chamber 14 is provided with an air outlet 111. The laser head 2 is then movably provided in the front chamber 13 to perform laser processing, and the fan component 5 is provided in the rear chamber 14 and is opposite to the air outlet 111. In this way, exhaust gas in the front chamber 13 flows into the rear chamber 14 under an effect of the fan component 5 and is finally discharged to an outside from the air outlet 111.

In summary, the laser processing device 100 embeds the fan component 5 in the rear chamber 14, so that the fan component 5 is prevented from protruding from the housing structure 1 and occupying a space outside the housing structure 1. This not only improves space utilization of a chamber of the housing structure 1 and makes a structure of the laser processing device 100 more compact, but also improves neatness of an appearance of the laser processing device 100.

In some embodiments of the present application, the housing structure 1 includes an outer shell body 11 and a partition 12. The partition 12 is provided within the outer shell body 11 to divide a chamber of the outer shell body 11 into the front chamber 13 and the rear chamber 14. An exhaust port 121 is formed in the partition 12 to communicate the front chamber 13 and the rear chamber 14. The exhaust port 121 is opposite to the air outlet 111, and the fan component 5 is provided between the exhaust port 121 and the air outlet 111.

In this embodiment, the partition 12 is provided within the outer shell body 11 to divide the chamber of the outer shell body 11 into the front chamber 13 and the rear chamber 14, and the exhaust port 121 is formed in the partition 12 to communicate the front chamber 13 and the rear chamber 14. The exhaust port 121 is opposite to the air outlet 111, and the fan component 5 is provided between the exhaust port 121 and the air outlet 111. Gas in the front chamber 13 passes through the exhaust port 121 and enters the rear chamber 14 under an effect of the fan component 5, and is then directly discharged to the outside from the air outlet 111, which is able to reduce a residence time of exhaust gas in the rear chamber 14 and improve an exhaust efficiency of the fan component 5.

The laser processing device 100 further includes a control component. In some embodiments of the present application, the control component is provided in the rear chamber 14 and is arranged side by side with the fan component 5. In this embodiment, the control component and the fan component 5 are arranged side by side in the rear chamber 14, which is able to effectively utilize an internal space of the device and improve a utilization rate of the rear chamber 14.

In an embodiment, two baffles 18 are provided in the rear chamber 14 to divide the rear chamber 14 into a first chamber 131, a second chamber 132, and a third chamber 133 that are arranged side by side. The first chamber 131 and the third chamber 133 are respectively provided at two sides of the second chamber 132. The exhaust port 121 and the air outlet 111 are both communicated with the second chamber 132, and the fan component 5 is provided in the second chamber 132. The control component includes a first control element 31 and a second control element 32 that are electrically connected to each other. For example, the first control element 31 is one of a main control board and a power module, and the second control element 32 is another one of the main control board and the power module. Of course, the first control element 31 and the second control element 32 may also be other required elements such as a communication module or a wireless connection module, and no limitation is made in this regard. The first control element 31 is provided in the first chamber 131, the second control element 32 is provided in the third chamber 133, and the fan component 5 is electrically connected to the first control element 31 or the second control element 32.

In this embodiment, the rear chamber 14 is divided into three independent chambers, namely a first chamber 131, a second chamber 132, and a third chamber 133. The first control element 31 is then provided in the first chamber 131, the fan component 5 is provided in the second chamber 132, and the second control element 32 is provided in the third chamber 133, thereby reasonably partitioning the rear chamber 14 so that an internal layout of the device is clearer and more orderly and facilitating modular management of the device. In addition, by respectively providing the first control element 31 and the second control element 32 in different chambers, electromagnetic interference and heat radiation between the first control element 31 and the second control element 32 are able to be reduced, which improves stability and reliability of the device.

The fan component 5 is electrically connected to the first control element 31 through a first wire harness, and the second control element 32 is electrically connected to the first control element 31 through a second wire harness. In an embodiment, a wire-passing hole 1411 for a wire harness to pass through is formed in the baffle 18.

In this embodiment, by forming the wire-passing hole 1411 in the baffle 18 to allow the wire harness to pass through, a fixing and routing of the wire harness are able to be maintained, which reduces possible swinging or shifting of the wire harness during operation of the device.

The wire-passing hole 1411 is provided at a top portion of the baffle 18 and extends to a top edge of the baffle 18, that is, a notch is formed at the top edge of the baffle 18 to form the wire-passing hole 1411. In this way, when the fan component 5 or the control component needs to be overhauled, disassembly and reconnection of the wire harness are able to be facilitated.

In some embodiments of the present application, the first control element 31 is attached to a side of the partition 12 facing the first chamber 131, and the second control element 32 is attached to a bottom wall of the third chamber 133. In this case, “attached” may refer to close fitting or fixing via adhesion.

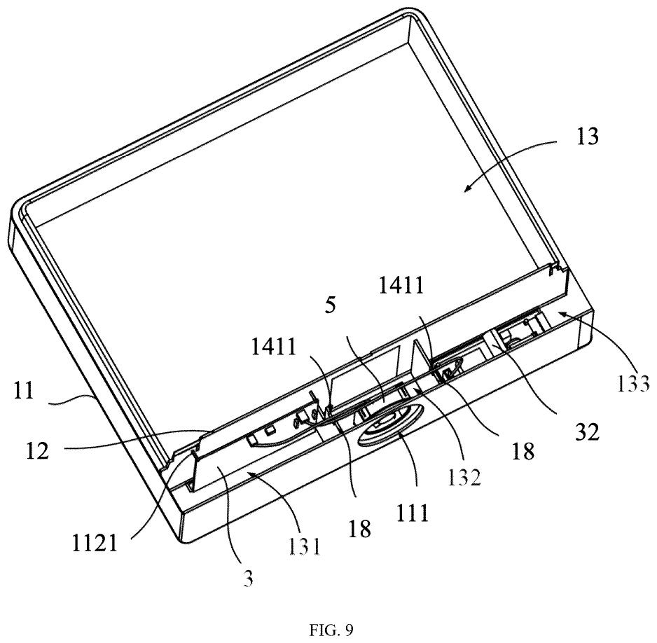

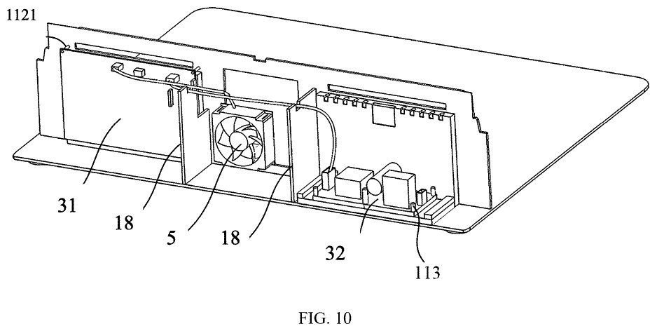

For example, the first control element 31 is a main control board, and the second control element 32 is a power module. The first control element 31 is vertically provided in the first chamber 131 and is fixedly connected to the partition 12, so that occupation of a larger space caused by horizontal placement of the first control element 31 is able to be avoided. Referring to FIG. 9 and FIG. 10, a plurality of first mounting posts 1121 protrude from the side of the partition 12 facing the first chamber 131, and the first control element 31 is fixedly connected to the first mounting posts 1121 by fasteners. The second control element 32 is provided in the third chamber 133 and is fixedly connected to the bottom wall of the third chamber 133, which ensures stability of the second control element 32 during operation of the device. Similarly, a plurality of second mounting posts 1131 protrude from the bottom wall of the third chamber 133, and the second control element 32 is fixedly connected to the second mounting posts 1131 by fasteners. The fasteners used may be screws, so that the first control element 31 and the second control element 32 are able to be conveniently disassembled and reassembled when an overhaul is needed.

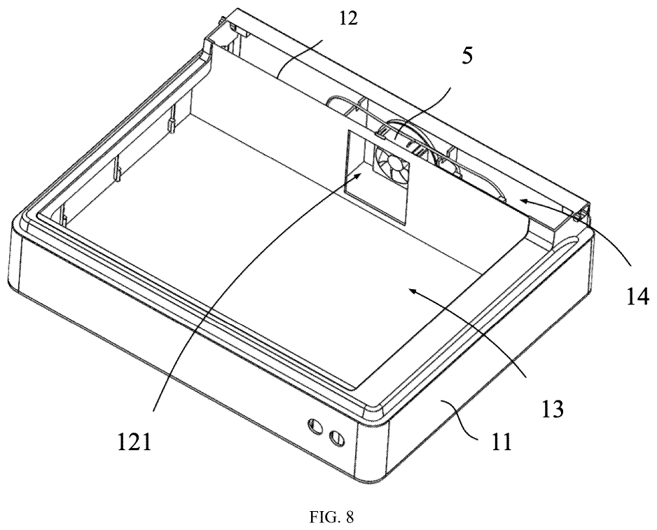

As shown in FIG. 7 and FIG. 8, in some embodiments of the present application, the housing structure 1 further includes a top plate 151, and the top plate 151 is detachably provided to cover a top of the rear chamber 14. The top plate 151 is used to close the rear chamber 14 so as to protect the fan component 5 and the control component in the rear chamber 14, and the top plate 151 is detachably connected to the outer shell body 11, so that assembly and overhaul of the fan component 5 and the control component are facilitated.

In this case, a pick-and-place opening is formed at a top of the front chamber 13, and the housing structure 1 further includes a cover plate 17, and the cover plate 17 is used to open or cover the pick-and-place opening. The cover plate 17 may have a connection relationship with the outer shell body 11 or the top plate 151. For example, the cover plate 17 may be rotatably connected to the outer shell body 11 or the top plate 151 so that the pick-and-place opening is opened or covered by rotating the cover plate 17, or the cover plate 17 may be slidably connected to the outer shell body 11 so that the pick-and-place opening is opened or covered by sliding the cover plate 17. Of course, the cover plate 17 and the outer shell body 11 may also have no connection relationship, that is, the two are provided as separate members. When the pick-and-place opening needs to be covered, the cover plate 17 is directly placed on the outer shell body 11, and when the pick-and-place opening needs to be opened, the cover plate 17 is directly taken away. Therefore, the present application does not limit the connection between the cover plate 17 and the outer shell body 11 as long as the pick-and-place opening is able to be opened and covered, so that an operator is facilitated to place a workpiece into the front chamber 13 or take out a processed workpiece from the front chamber 13. In an embodiment, during laser processing, when the cover plate 17 is in a covered state, laser overflow is able to be avoided, and diffusion of smoke and dust generated during the laser processing to the outside and invasion of foreign objects from the outside into the front chamber 13 to affect processing are also able to be avoided.

In some embodiments of the present application, the laser processing device 100 further includes a lighting lamp 8, and the lighting lamp 8 is provided in the front chamber 13 and is used to illuminate a workpiece. In an embodiment, the lighting lamp 8 may be provided at a left side and/or a right side of the front chamber 13. In this way, when the lighting lamp 8 is operating, a user usually stands at a front side of the front chamber 13, and the lighting lamp 8 is provided at the left side and/or the right side of the front chamber 13, so that light emitted from the lighting lamp 8 is prevented from directly irradiating eyes of the user, thereby improving safety in use.

In some embodiments of the present application, one of the cover plate 17 and the outer shell body 11 is provided with a Hall sensor 92, and the other one is provided with a magnetic element 91 configured to cooperate with the Hall sensor 92. The magnetic element 91 is used to detect opening and closing of the cover plate 17, and the magnetic element 91 and the lighting lamp 8 are both electrically connected to a control component in the laser processing device 100, and the control component controls brightness of the lighting lamp 8 according to a sensing signal of the magnetic element 91.

It can be understood that the magnetic element 91 cooperates with the Hall sensor 92 to generate a sensing signal when the cover plate 17 is opened or closed. When the magnetic element 91 senses the Hall sensor 92, this indicates that the cover plate 17 covers the pick-and-place opening. At this time, the magnetic element 91 sends a first sensing signal to a control element (for example, the first control element 31 or the second control element 32) electrically connected thereto. After receiving the first sensing signal, the control element controls brightness of the lighting lamp 8 according to the first sensing signal. Since the cover plate 17 covers the pick-and-place opening at this time, brightness of the lighting lamp 8 may be increased. When the magnetic element 91 does not sense the Hall sensor 92, this indicates that the cover plate 17 is in an open state. At this time, the magnetic element 91 sends a second sensing signal to the control element electrically connected thereto. After receiving the second sensing signal, the control element controls brightness of the lighting lamp 8 according to the second sensing signal. Since the cover plate 17 is in the open state at this time, brightness of the lighting lamp 8 may be reduced, or the lighting lamp 8 may be directly turned off.

In summary, in this embodiment, one of the cover plate 17 and the outer shell body 11 is provided with the Hall sensor 92, and the other one is provided with the magnetic element 91, such as a magnet. The magnetic element 91 and the lighting lamp 8 are both electrically connected to a control element in the laser processing device 100. In this way, brightness of the lighting lamp 8 is associated with opening and closing of the cover plate 17, so that the lighting lamp 8 can rapidly adjust its own brightness according to opening and closing of the cover plate 17, thereby improving intelligence and flexibility of the laser processing device 100.

The foregoing description is merely exemplary embodiments of the present application and is not intended to limit a patent scope of the present application. Any equivalent structural changes made under a technical concept of the present application by using contents of the specification and the drawings of the present application, or any direct or indirect application of the technical solutions to other related technical fields, fall within a protection scope of the present application.

What is claimed is:

1. A laser processing device, comprising:
a laser head;
a control component; and
a housing structure having a front chamber and a rear chamber communicating with the front chamber,
wherein the laser head is movably provided in the front chamber, the control component is provided in the rear chamber, the front chamber is communicated with an external environment such that external gas is capable of entering the front chamber, and the rear chamber is communicated with the external environment such that gas in the front chamber is discharged to an outside through the rear chamber.

2. The laser processing device according to claim 1, wherein an air inlet chamber communicating with the external environment is isolated within the rear chamber, and the air inlet chamber is communicated with the front chamber such that the external gas is capable of entering the front chamber through the air inlet chamber.

3. The laser processing device according to claim 2, wherein an air guide pipe configured to communicate the air inlet chamber and the front chamber is provided between the air inlet chamber and the front chamber.

4. The laser processing device according to claim 2, wherein a cover is provided in the rear chamber, the air inlet chamber is formed inside the cover, an air inlet communicating with the air inlet chamber is provided on the housing structure, and the external gas enters the air inlet chamber through the air inlet.

5. The laser processing device according to claim 4, wherein:
the housing structure comprises an outer shell body and a partition;
the partition is provided within the outer shell body to divide a chamber of the outer shell body into the front chamber and the rear chamber;
the partition is provided with an exhaust port to communicate the front chamber and the rear chamber;
the rear chamber is provided with an air outlet communicating with the outside; and
gas in the front chamber sequentially flows through the exhaust port and the air outlet to be discharged to the outside.

6. The laser processing device according to claim 5, further comprising:
a fan component, wherein:
the exhaust port and the air outlet are opposite to each other;
the fan component is provided in the rear chamber and located between the exhaust port and the air outlet; and
the cover is provided on a side of the partition facing the rear chamber, and the cover is enclosed with the partition to form the air inlet chamber.

7. The laser processing device according to claim 6, wherein:
a bottom wall of the cover is flush with a bottom wall of the outer shell body, and the air inlet is formed on the bottom wall of the outer shell body; and
a support structure is provided at a bottom surface of the housing structure and is configured to raise the bottom surface of the housing structure.

8. The laser processing device according to claim 5, wherein the cover is provided with air guide holes, the partition is provided with ventilation holes, and gas in the air inlet chamber enters the front chamber through the air guide holes and the ventilation holes.

9. The laser processing device according to claim 8, wherein a top surface of the cover is lower than a top surface of the partition, the air guide hole is formed on a top wall of the cover, and the ventilation hole is provided at the partition and located above the air guide hole.

10. The laser processing device according to claim 9, wherein:
the ventilation hole is provided at a top of the partition and extends to a top edge of the partition;
a pick-and-place opening is formed at a top of the front chamber; and
the housing structure further comprises a cover plate configured to cover or uncover the pick-and-place opening, and the cover plate is fitted against the top edge of the partition when covered.

11. The laser processing device according to claim 8, wherein:
the rear chamber is partitioned to form an air guide chamber and an exhaust chamber arranged side by side;
the cover is provided in the air guide chamber such that the air guide hole is communicated with the air guide chamber;
the ventilation hole is communicated with the air guide chamber, such that gas flow in the air inlet chamber enters the air guide chamber through the air guide hole and then enters the front chamber through the ventilation hole; and
both the exhaust port and the air outlet are communicated with the exhaust chamber, and the control component is provided within the air guide chamber.

12. The laser processing device according to claim 11, wherein:
two air guide chambers are provided, the two air guide chambers are respectively provided on opposite sides of the exhaust chamber, and one cover is provided in each air guide chamber;
the control component comprises a first control element and a second control element electrically connected to the first control element;
the first control element is provided in one of the air guide chambers, the second control element is provided in another one of the air guide chambers;
the laser head is electrically connected to the first control element or the second control element; and
two baffles are provided in the rear chamber to divide the rear chamber into the air guide chambers and the exhaust chamber.

13. The laser processing device according to claim 1, further comprising:
a track mechanism, wherein:
a pick-and-place opening is formed at a top of the front chamber, and the housing structure further comprises a cover plate configured to cover or uncover the pick-and-place opening;
the track mechanism comprises two first tracks and a second track;
the two first tracks are provided at opposite sides of the front chamber along a first direction, and the second track is reciprocally provided on the two first tracks along a second direction; and
the laser head is movably provided on the second track.

14. A laser processing device, comprising:
a housing structure having a front chamber and a rear chamber communicating with each other and having an air outlet provided at a side wall of the rear chamber;
a laser head movably provided within the front chamber; and
a fan component provided in the rear chamber and located opposite to the air outlet.

15. The laser processing device according to claim 14, wherein the housing structure comprises an outer shell body and a partition, the partition is provided within the outer shell body to divide a chamber of the outer shell body into the front chamber and the rear chamber, an exhaust port is provided on the partition to communicate the front chamber and the rear chamber, the exhaust port is opposite to the air outlet, and the fan component is provided between the exhaust port and the air outlet.

16. The laser processing device according to claim 15, further comprising:
a control component provided in the rear chamber and arranged side by side with the fan component, wherein:
the rear chamber is provided with two baffles to divide the rear chamber into a first chamber, a second chamber and a third chamber arranged side by side;
the first chamber and the third chamber are respectively provided on opposite sides of the second chamber, the exhaust port and the air outlet are communicated with the second chamber, and the fan component is provided in the second chamber; and
the control component comprises a first control element and a second control element electrically connected to the first control element, the first control element is provided in the first chamber and the second control element is provided in the third chamber, and the fan component is electrically connected to the first control element or the second control element.

17. The laser processing device according to claim 16, wherein:
the first control element is one of a main control board and a power module, and the second control element is another one of the main control board and the power module; and
a baffle is provided with a wire-passing hole for a wire harness to pass through, and the wire-passing hole is provided at a top of the baffle and extends to a top edge of the baffle.

18. The laser processing device according to claim 16, wherein:
the first control element is attached to a side of the partition facing the first chamber, and the second control element is attached to a bottom wall of the third chamber; and
a first mounting post protrudes from the side of the partition facing the first chamber, and the first control element is fixedly connected to the first mounting post by fasteners; and/or
a second mounting post is provided on the bottom wall of the third chamber, and the second control element is fixedly connected to the second mounting post by fasteners.

19. The laser processing device according to claim 16, further comprising:
a lighting lamp provided within the front chamber, wherein:
a pick-and-place opening is formed at a top of the front chamber,
the housing structure further comprises a top plate detachably provided at a top of the rear chamber and a cover plate configured to cover or uncover the pick-and-place opening;
one of the cover plate and the outer shell body is provided with a magnetic element, and another one of the cover plate and the outer shell body is provided with a Hall sensor configured to cooperate with the magnetic element;
the Hall sensor is configured to detect opening and closing of the cover plate, the Hall sensor and the lighting lamp are electrically connected to the control component of the laser processing device; and
the control component is configured to control brightness of the lighting lamp according to a sensing signal of the Hall sensor.

20. The laser processing device according to claim 14, further comprising:
a track mechanism, wherein:
the track mechanism comprises two first tracks and a second track, the two first tracks are provided at opposite sides of the front chamber along a first direction, the second track is reciprocally provided on the two first tracks along a second direction, and the laser head is movably provided on the second track.
